(19) United States
(12) Patent Application Publication
(10) Pub. No.: US 2026/0052402 A1
(43) Pub. Date: Feb. 19, 2026

(54) SYSTEM AND METHOD FOR OPTIMIZING CELLULAR NETWORK PERFORMANCE

(71) Applicant: AT&T Intellectual Property I, L.P., Atlanta, GA (US)

(72) Inventors: Serkan Isci, Plainsboro, NJ (US); Yaron Kanza, Fair Lawn, NJ (US); Velin Kounev, Summit, NJ (US); Yusef Shaqalle, Minneapolis, MN (US); Slawomir Mikolaj Stawiarski, Carpentersville, IL (US); Zhangyu Wang, Bentonville, AR (US)

(73) Assignee: AT&T Intellectual Property I, L.P., Atlanta, GA (US)

(21) Appl. No.: 18/806,018

(22) Filed: Aug. 15, 2024

(51) Int. Cl. H04W 24/02

(52) U.S. Cl. CPC H04W 24/02

(57) ABSTRACT

Aspects of the subject disclosure may include, for example, a device, including: a processing system including a processor; and a memory that stores executable instructions that, when executed by the processing system, facilitate performance of operations of: partitioning a geographic area into a plurality of bins; assigning an agent to each antenna that provides communication services in the geographic area, wherein the agent executes an action that adjusts settings for network parameters for the antenna to improve coverage quality; initializing random settings for the network parameters; computing updated coverage quality, signal strength and interference for each bin in the plurality at a setting proposed by the agent; recording the updated coverage quality, the signal strength and the interference in a history; rewarding the agent for improvements; repeating the computing, the recording and the rewarding a preset maximum number of times at most or until achieving an overall coverage quality improvement goal; providing the history to a policy net as an epoch; and iterating the initializing, computing, recording, rewarding and repeating a maximum number of epochs at most or until the policy net converges. Other embodiments are disclosed.

### FIELD OF THE DISCLOSURE

The subject disclosure relates to a system and method for optimizing cellular network performance.

### BACKGROUND

Demand for bandwidth in cellular networks has been rising rapidly. The number of cellular devices that are connected to the network has been growing, and applications like streaming media and online social networks have led to a substantial increase in the traffic volume. To cope with the growing demand for network services, new generations of cellular networks, like fourth generation (4G) and fifth generation (5G), radio frequency (RF) technology have been developed to utilize high frequencies such as millimeter wave and arrays of antennas (MIMO). Such cellular transmissions are susceptible to the effects incurred from the geospatial environment. Obstacles like buildings, trees, and the terrain obstruct, reflect, and refract the electromagnetic transmissions of antennas, and the effect on the environment grows as the frequencies are increased. Hence, the design and optimization of new cellular networks has become difficult but critical, especially in urban areas.

When planning a cellular network, the location of each antenna and its height are selected based on the availability of network towers in the area (and regulatory restrictions). The goal is to provide effective cellular coverage. If a device is located too far from any antenna or when geospatial obstacles obstruct the transmission, the signal strength will be low. However, when a device receives radio-frequency signals from several antennas, signals from some antennas may interfere with the signals of other antennas.

There have been many ways to improve the performance of cellular networks, e.g., increasing the RF coverage area and minimizing interference. Performance enhancements in cellular networks can be achieved through various methods, including reusing frequencies in licensed spectrum, splitting cells (a.k.a. sectoring), fine tuning RF characteristics and managing interference.

Cellular networks optimize the use of the available radio spectrum by employing a technique known as frequency reuse. Frequency reuse allows for the same frequencies to be used in different cells that are sufficiently separated to avoid interference. By allocating the same frequency bands to non-adjacent cells, networks can maximize coverage and capacity, minimizing interference.

Splitting cells into sectors increases the capacity of cellular systems. Cell splitting involves dividing a large cell into smaller cells with lower antenna height and lower power, which increases the number of channels and frequency reuse. Sectoring uses directional antennas to divide a cell into sectors, reducing co-channel interference and increasing the signal to interference (and noise) ratio (SINR). A microcell zone concept uses multiple transmitters and receivers in a cell, connected to a single base station that shares the same channel, thereby reducing the handoff load and interference.

RF optimization is a critical process in wireless communication networks, aiming to enhance the efficiency, coverage, and quality of the radio signal. RF optimization involves a series of techniques and procedures to fine-tune various parameters within the RF domain to ensure optimal performance of the network. The numerous parameters and plethora of Radio Access Network (RAN) cells and User Equipment (UE) make this process extremely complex.

Effective, real-time management of interference is crucial to fully reaping the benefits of Long-Term Evolution (LTE) wireless technology. A multipronged approach that involves both the RAN and the UEs best serves the need to minimize interference. Future 5G wireless communication networks are largely characterized by small cell deployments, typically in the range of 200 meters of radius/cell, at most. This implementation delivers various advantages such as high data rate and low signal delay. However, it also suffers from various issues such as inter-cell, intra-cell, and inter-user interferences. Several other issues arise from interference management for 5G network from the perspective of heterogeneous network and device-to-device communication.

The effectiveness of these methods can vary based on factors such as the specific network infrastructure, the geographical area, and the number of users on the network. Network professionals and carriers must tailor their techniques to the environment, capacity and loading of the cellular network.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system for optimizing cellular network performance functioning within the communication network of FIG. 1 in accordance with various aspects described herein.

FIG. 2B depicts an illustrative embodiment of a method of training a reinforcement learning model to optimize cellular network coverage in accordance with various aspects described herein.

FIG. 2C are four graphs illustrating a distribution of different forms of geospatial information and alignment with a geospatial distribution of raytracing-based signal strength variance.

FIG. 2D are two graphs illustrating an evaluation of a trained policy net compared to the baseline methods.

FIG. 2E are two graphs illustrating an ablation study of a trained policy net compared to baseline methods demonstrating how geospatial importance sampling and multi-path coefficient improve the reinforcement learning.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method for optimizing cellular network performance. Other embodiments are described in the subject disclosure.

One or more aspects of the subject disclosure include a device, including: a processing system including a processor; and a memory that stores executable instructions that, when executed by the processing system, facilitate performance of operations of: partitioning a geographic area into a plurality of bins; assigning an agent to each antenna that provides communication services in the geographic area, wherein the agent executes an action that adjusts settings for network parameters for the antenna to improve coverage quality; initializing random settings for the network parameters; computing updated coverage quality, signal strength and interference for each bin in the plurality at a setting proposed by the agent; recording the updated coverage quality, the signal strength and the interference in a history; rewarding the agent for improvements; repeating the computing, the recording and the rewarding a preset maximum number of times at most or until achieving an overall coverage quality improvement goal; providing the history to a policy net as an epoch; and iterating the initializing, computing, recording, rewarding and repeating a maximum number of epochs at most or until the policy net converges.

One or more aspects of the subject disclosure include a non-transitory machine-readable medium, with executable instructions that, when executed by a processing system including a processor, facilitate performance of operations, including: implementing a geospatial ray tracer that computes signal strength of a radio frequency emission from an antenna at a location bin in a geographical area, wherein the geospatial ray tracer uses a multi-path coefficient to compute the signal strength, wherein the geospatial ray tracer computes coverage quality for the location bin responsive to an average variance of the signal strength exceeding a threshold, and wherein the coverage quality is provided to a reinforcement learning model; and training the reinforcement learning model to discover network parameter settings that maximize radio communication coverage and minimize radio frequency interference in the geographical area.

One or more aspects of the subject disclosure include a method of: assigning, by a processing system including a processor, an agent to each antenna that provides communication services in a geographic area, wherein the geographic area is partitioned into a plurality of bins, and wherein the agent executes an action that adjusts settings for network parameters for the antenna to improve coverage quality; initializing, by the processing system, random settings for the network parameters; computing, by the processing system, updated coverage quality, signal strength and interference for each bin in the plurality at a setting proposed by the agent; recording, by the processing system, the updated coverage quality, the signal strength and the interference in a history; rewarding, by the processing system, the agent for improvements; repeating, by the processing system, the computing, the recording and the rewarding a preset maximum number of times at most or until achieving an overall coverage quality improvement goal; providing, by the processing system, the history to a policy net as an epoch; iterating, by the processing system, the initializing, computing, recording, rewarding and repeating a maximum number of epochs at most or until the policy net converges.

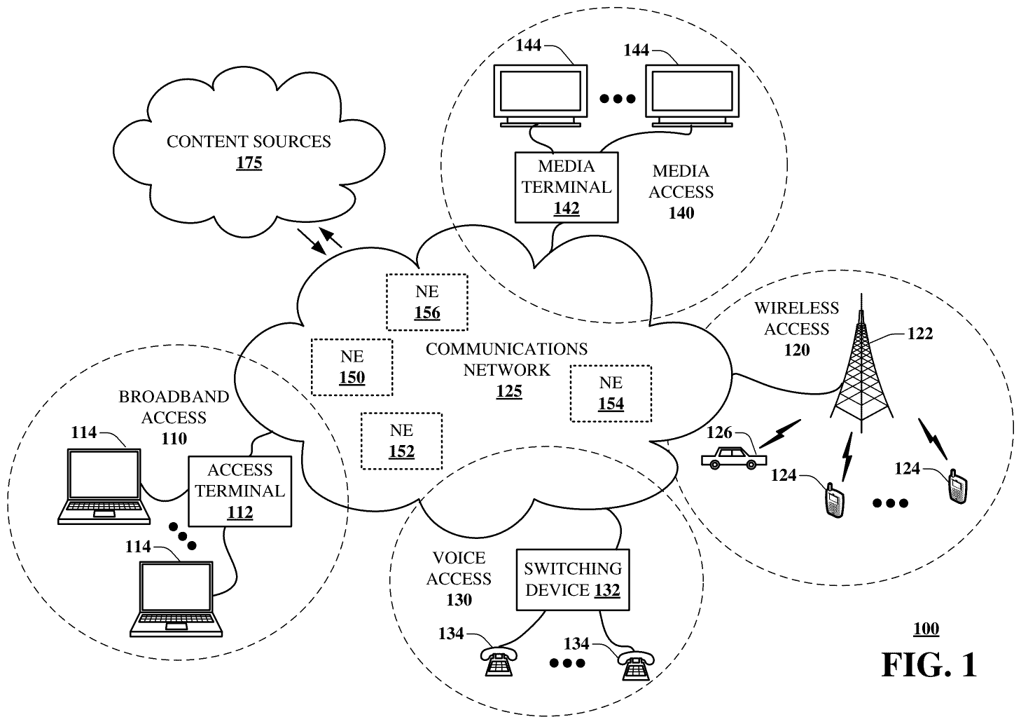

Referring now to FIG. 1, a block diagram is shown illustrating an example, non-limiting embodiment of a system 100 in accordance with various aspects described herein. For example, system 100 can facilitate in whole or in part partitioning a geographic area into a plurality of bins; assigning an agent to each antenna; initializing random settings for the network parameters; computing updated coverage quality, signal strength and interference for each bin in the plurality at a setting proposed by the agent; recording the updated coverage quality, the signal strength and the interference in a history; rewarding the agent for improvements; and providing the history to a policy net as an epoch. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, Ultra Wideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

To optimize the network and increase the coverage while decreasing the interference, cellular operators change the tilt of antennas and their transmission power. Optimization of the tilt and power of antennas should be done in real-time to address evolving situations, like changes in the demand for network coverage, and to cope with a cell outage. Cell outage compensation is a self-healing function often employed by Self-Organizing Networks (SON). The goal of SON is to mitigate the degradation of coverage, capacity, and service quality in case of an outage of a cell or a site. Cell outage compensation is executed by tuning the electrical tilt of antennas and changing the downlink received power level, in the cells surrounding the affected site. This requires real-time automation and fast reaction to the outage, while considering the features of the cellular network and the geospatial environment. The system must perform the necessary computations extremely fast when optimizing large-scale areas. If planning at the scale of a large city or even a country is too slow, some areas would seldom be optimized, and this could affect the quality of service and the availability of the network.

For an effective computation of the coverage of cellular antennas, an accurate propagation model of the radio transmission should be combined with a detailed 3D model of the geospatial environment. Such a computation is expensive, so it could be ineffective in an optimization where a large number of states should be explored. If there are n sectors in an area and each sector has t tilt levels, the search space has a size of tⁿ. For example, with 20 antennas and 10 tilt levels, the search space will have more than 10 trillion combinations. So, even if only a small portion of the search space is explored in the optimization, each step should be extremely fast, which is challenging over a detailed geospatial model.

In an embodiment, a system and method for optimizing cellular network performance includes deep reinforcement learning supported by an artificial intelligence (AI) enhanced ray tracer, which analyzes a detailed 3D model of the geospatial environment, for optimization of antenna tilts in cellular networks. The embodiment includes two significant mechanisms: (1) geospatial importance sampling and (2) analyzing multi-path coefficients. These mechanisms efficiently pass geospatial information to the reinforcement learning model. This approach can be used for fast and scalable optimization of tilt levels of cellular antennas. An experimental evaluation shows that reinforcement learning has superior results when compared to greedy search, simulated annealing and Bayesian optimization. Reinforcement learning is effective and can cope with optimization problems that are at a greater scale than settings that other algorithms can cope with.

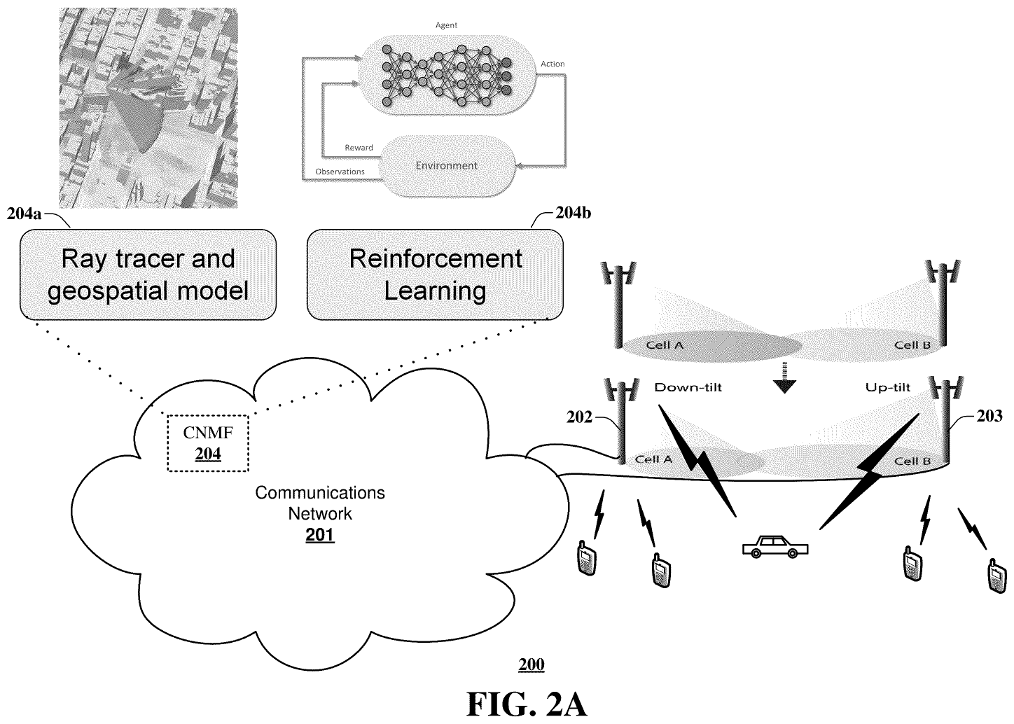

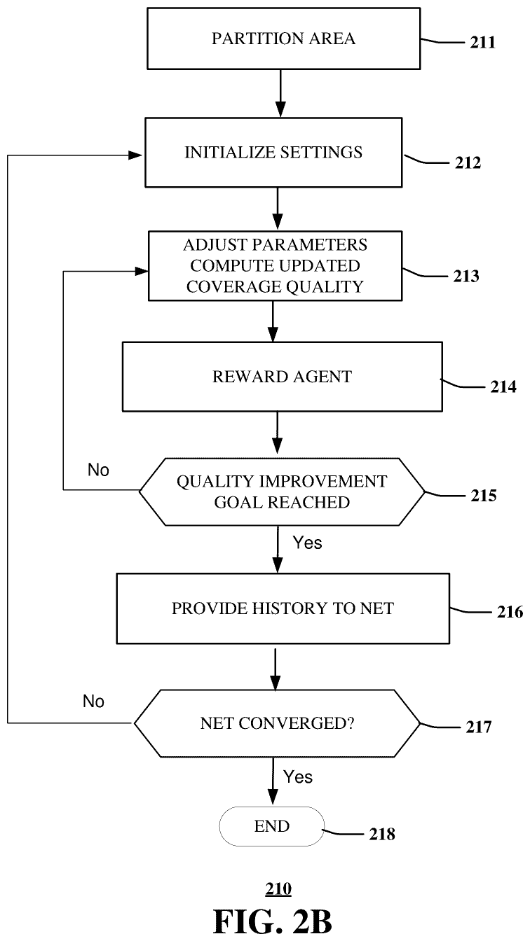

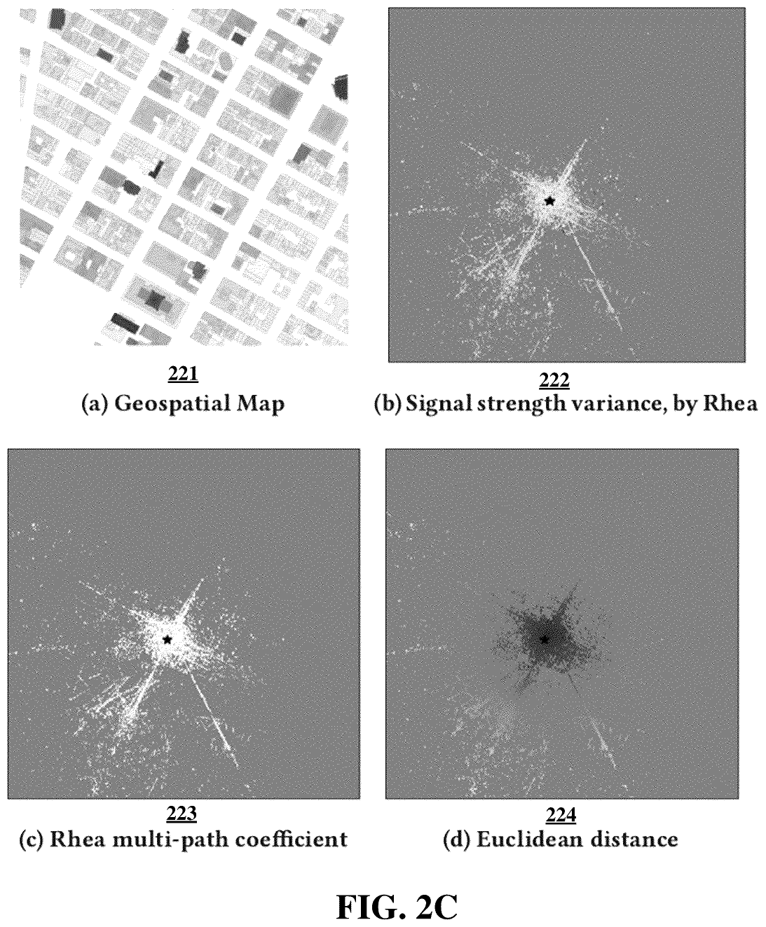

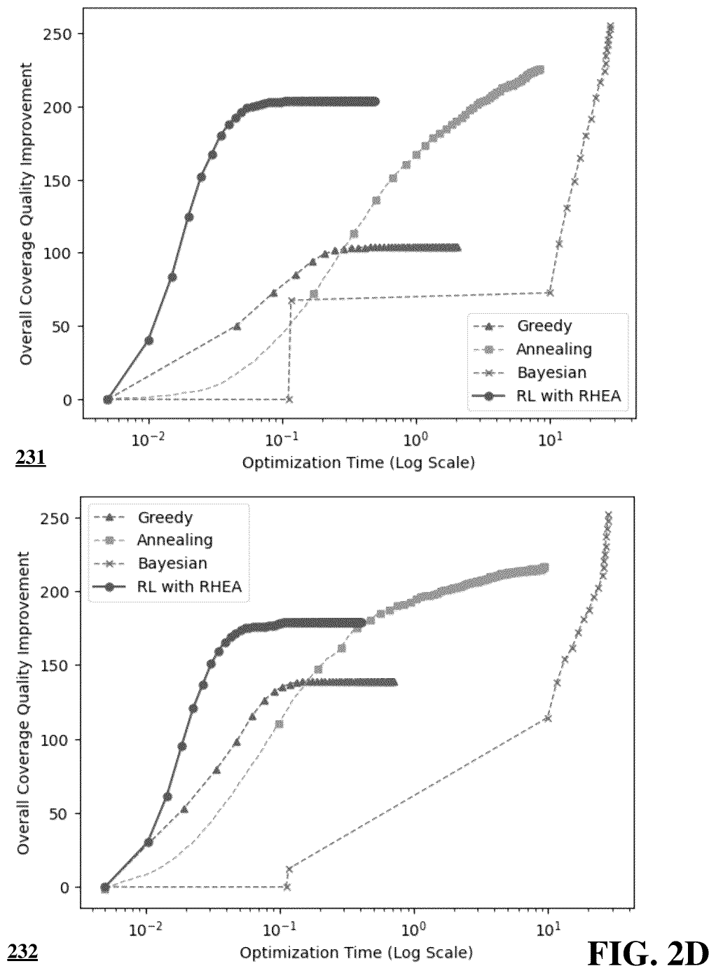

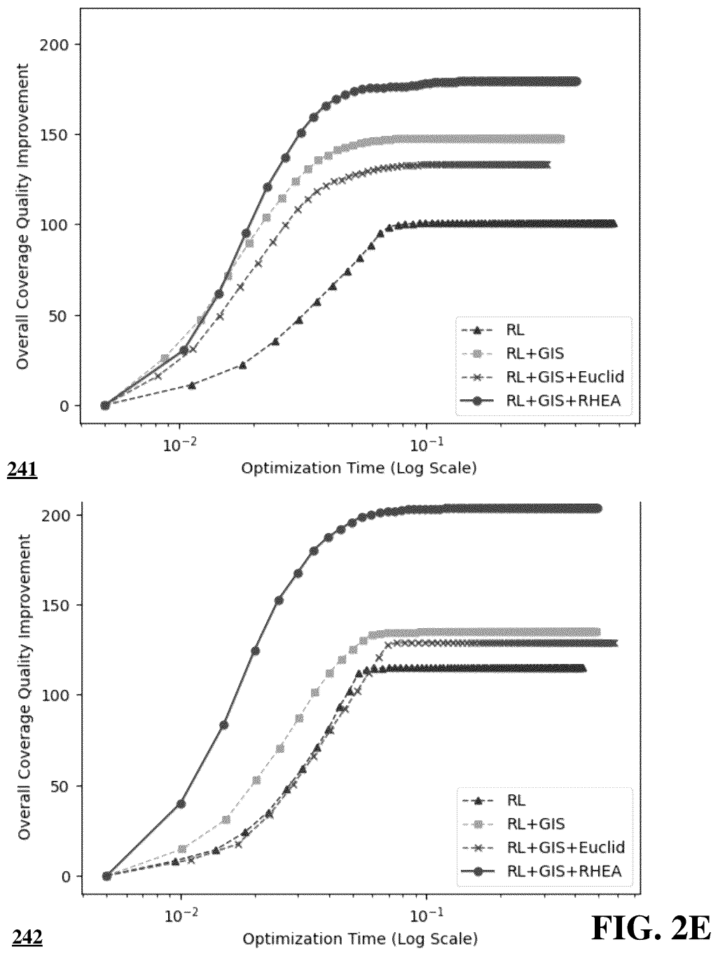

FIG. 2A is a block diagram illustrating an example, non-limiting embodiment of a system for optimizing cellular network performance functioning within the communication network of FIG. 1 in accordance with various aspects described herein. As shown in FIG. 2A, system 200 comprises a communications network 201 having a plurality of cells 202, 203 and a cellular network management function (CNMF 204). CNMF 204 includes two components: a ray-tracer/geospatial model (RT 204a), and a reinforcement learning engine (RL 204b), which are described in more detail below. Together, these two components enable CNMF 204 to optimize RF coverage and minimize interference, thereby improving the overall performance of the cellular network to provide communication services to the UEs. As illustrated in an exemplary embodiment, CNMF 204 commands RANs in communications network 201, including cell 202 (site A) and cell 203 (site B) to optimize network performance while providing said communication services by adjusting the tilt of the antennas, among other adjustments. It should be noted that this illustration and the following description is provided in the context of adjusting the tilt of an antenna RF radiation pattern, which is a bit over-simplified since there are many other aspects of the RAN may adjusted by CNMF 204 to improve overall performance. There are features that can be adjusted while the system is online and operational, in real time, and features that can be adjusted offline. Features that can be adjusted online may include (in addition to tilt, power, and frequency) beam width and number of beams, when using MIMO in 5G. Features that must be adjusted when the system is offline include the azimuth of directional antennas or sectors, the height of the antenna on the tower, the type and the technology (e.g., 4G vs 5G) of the antenna. In beam forming the frequency, phase and amplitude can be changed and consequently, the system can achieve a change in the signal direction, delay, and beam width.

RL 204b solves the optimization problem by trial-and-error learning. In each step, multiple agents take actions independently and apply changes to the RAN environment. The agents observe the new states and receive rewards accordingly. The history of the changes and the rewards are recorded and used to train a model for maximizing the rewards. For example, if for every antenna there are 15 tilt levels, where 0 is an up tilt towards the horizon and 14 is a down tilt towards the ground, an agent is assigned to each antenna. An action of an agent is an increase (decrease) of the tilt level by 1. So, for n antennas, in each step there are 3ⁿ combinations of possible changes, where each antenna can be tilted up, tilted down or have its tilt level kept unchanged. For n antennas with 15 tilt levels, the entire search space has a size of 15ⁿ.

The geospatial environment consists of a model for the environment and the antennas (with their features) in the environment. The ground is partitioned into bins by a grid pattern. For example, each bin may have a size of 4 meters squared. For every combination of tilt levels, CNMF 204 computes the coverage of each antenna and the state of each bin (dominance, interference, no coverage, etc.), using a geospatial ray tracing algorithm. In an embodiment, RT 204a implements an algorithm known as RHEA. See, Czapiga et al., Playable Ray Tracing for Real-Time Exploration of Radio Propagation in Wireless Networks in Proc. of the 30th International Conference on Advances in Geographic Information Systems (ACM. 2022), which is incorporated by reference herein. CNMF 204 computes signal strength for each bin b by combining the transmissions that reach b. Coverage is defined as the set of bins in which the received signal strength exceeds a preset threshold. Interference within a bin, whose carrier frequency is f, is considered to be unacceptable if the received signal power from the strongest cell transmitting at f (the serving cell) is not sufficiently stronger than the net received signal power from all other cells operating at the same frequency f. Note that the selection of the bin size is affected by the tradeoff between the accuracy of the geospatial model and the computation time. In practice, a partition into 16 m×16 m bins is sufficiently accurate for tilt optimization.

CNMF 204 processes an algorithm that gathers and manages the following information for each antenna A and bin b: (1) the strength of the signal from A at b, (2) the coverage quality of A at b, (3) the strongest signal at b, (4) the level of interference at b, and (5) the multi-path coefficient, which is the difference between (i) the signal strength when considering all the paths from A to b, including indirect ones where reflection is involved, and (ii) the signal strength based on the direct path (line-of-sight) if such a path exists. To increase the efficiency, the algorithm processes a subset of the bins in each step. This subset is selected uniformly, and its size B is a hyperparameter of the algorithms.

When the system is training the model, it selects initial tilts at random (i.e., uniformly). This yields the initial environment state S^{(init)}. RHEA computes the overall coverage quality Q under this tilt setting. The goal is to find a tilt setting whose overall coverage quality is higher than Q^{(init)} by an improvement threshold T.

At each step, every agent executes an action that adjusts settings for network parameters for A that are commensurate with a network quality policy of the carrier of the cellular network. When an off-policy action is performed, a random action vector a is drawn uniformly from the action space. When an on-policy action is executed, a mini-batch of B bins is selected uniformly. Coverage quality, signal strength and interference are computed for the B bins, by RHEA. In an embodiment, the system uses a three-layer feed-forward neural network with a rectified linear unit (ReLU) activation as the policy net. The feed-forward network includes a hyperparameter ε, which is the probability of executing the off-policy action (while 1−ε is the probability of an on-policy action). The parameter ε decays as the number of training iterations grows. Thus, the effect of the decisions of the policy net grows over time.

In each step, the system updates the state and the previous state of the environment, denoted S^{(u)} and S^{(p)}, with coverage qualities Q^{(u)} and Q^{(p)}, respectively. For an agent A,

$${Q}_{A}^{( u )} and {Q}_{A}^{( p )}$$

are the updated previous coverage qualities in the bins where the signal from antenna A is the strongest (that is, bins in which A is the serving cell). We reward the agents for the way they improve Q^{(u)} in comparison to Q^{(p)}. The system implements a reward function based on the following three principles: (1) the reward function encourages the agents to cooperate to improve the overall coverage quality. Experiments show that if the system only rewards the agents for improving their individual coverage quality, they will execute greedy steps instead of improving the overall quality; (2) the reward function encourages the agents to have an appropriate individual coverage quality, not too high or too low. When an antenna serves too many bins, it may exceed its communication capacity. Serving too few bins is a waste of energy; and (3) the reward function discourages agents from competing for dominance in bin b if it is unlikely that they will be the serving cell of b. Experiments show that if an antenna has little chance of serving a bin (for example, the line of sight is blocked by a building), encouraging it to compete for dominance will only increase interference.

RL 204b enforces these principles by splitting the reward into five components: stepwise penalty(S), individual-improvement reward (II), global improvement reward (GI), winning reward (WR), and lose penalty (LP). Stepwise penalty encourages the agents to take active actions instead of remaining still but can also discourage agents to compete for dominance in bins that they cannot serve, because taking actions in that way will only result in receiving stepwise penalties. Individual improvement reward makes agents explore and avoid under-serving. Global improvement reward compensates agents which improve the overall coverage quality by helping other agents, such as reducing interference or lack-of-dominance. This encourages agents to cooperate. The winning reward is large compared to the other rewards, making cooperation more profitable. Lose penalty penalizes under-serving and over-serving agents, to enhance the individual improvement reward. Table 1 is a summary of the notations, definitions and formulations of these components:

TABLE 1
Components of the reward per agent

| Notation | Definition | Formulation |
|---|---|---|
| S | A constant penalty per action. | Negative hyperparameter if |
| | Encourages agents to change tilts. | Q^{(u)} − Q^{(P)} ≤ 0, 0 otherwise |
| II | Increasing coverage quality for agent A | $II = ( {Q}_{A}^{( u )} - {Q}_{A}^{( p )} \} / T$ |
| GI | Increasing overall coverage quality. | GI = (Q^{(u)} − Q^{(p)})/T |
| | Encourages agents to cooperate | |
| WR | Improving the initial coverage quality | Positive hyperparameter if |
| | by a margin of the winning threshold T. | Q^{(u)} - Q^{(init)} > T, 0 otherwise. |
| | Encourages the agents to cooperate | |
| LP | Penalty for under-serving or over-serving. | Negative hyperparameter if |
| | Agent A has its under-serving threshold | ${Q}_{A}^{( u )} < {T}_{A}^{( under )} or {Q}_{A}^{( u )} > {T}_{A}^{( over )}$ |
| | ${T}_{A}^{( under )} and over ‐ serving threshold {T}_{A}^{( over )} .$ | |

The system boosts training to scale up the global improvement reward when the overall coverage quality is low, because that encourages the policy net to explore larger parts of the search space, by jumping and exploring new areas, without penalty. To do so, ψ is a step function of the improvement ratio P=(Q^{(u)}−Q^{(init)})/T. ψ measures how close the current state is to the goal. Similarly, ψ helps to scale up the global improvement reward when the overall coverage quality is close to winning, when it is difficult to improve the coverage quality. At that stage, the agent needs a large reward for progress. The values of ψ are as follows:

| P | ≤0.05 | <0.1 | <0.2 | <0.5 | ≥0.5 and <0.8 | ≥0.8 |
|---|---|---|---|---|---|---|
| ψ | 20 | 10 | 5 | 2 | 1 | (1 + p)² |

The reward r_{A} for agent A is computed by:

$${r}_{A} = II + GI \times ψ + WR + LP + S$$

After computing the reward, CNMF 204 saves all the information (actions, updated tilts, updated environment state, and rewards) as one record of history, and moves on to the next step. The system terminates the process if the overall coverage quality improvement goal is achieved, or the number of steps exceeds a preset maximum. After termination, the system randomly initializes the tilts, and starts over again. The system repeats this process until the number of records exceeds the preset maximum history length M.

Next, the system feeds the history records to the policy net so that the model learns from past trials what actions may lead to higher rewards. More specifically, the system computes the loss and gradients by comparing the reward at each step with the expected reward (i.e., the expectation of rewards across the entire mini batch) using smooth L1 loss. Note that a reward discount factor γ is applied to weigh short-term rewards and long-term rewards. A lower γ means rewards received many steps later are less important. In the end, the system makes a copy of the policy net weights Wₚ and updates them by gradient descent with learning rate l, called the target net weights Wₜ. Then, the system updates the policy net weights by Wₚ=Wₚ+τ*Wₜ, where τ is a hyperparameter called the update rate. Finally, the system clears the history and starts over again. This round of iteration and training is called an epoch. The system repeats the process until the policy net converges (no change anymore) or the training exceeds the maximum number of epochs E.

CNMF 204 performs testing exactly the same way as the training described above, except for two things: 1) the policy net is fixed; 2) all actions are on-policy. Notice that both in training and testing, there is no specific information about the region of interest involved, such as locations of buildings and trees, but in the form of the RHEA multi-path coefficients. Therefore, a policy net trained on data obtained from one region can be naturally tested on data obtained from another region as long as RHEA has the geospatial information of that region, making our method geospatially generalized.

To reduce computational complexity, CNMF 204 computes a subset of the bins in each step. However, randomly selecting the bins often leads to a set that is not a good representation of the full set of bins, because many bins have a small effect on the training. For example, bins that are close to a single antenna or bins that are in obstructed areas and do not receive signal from any antenna have a small effect on the optimization. Bins that are covered by several antennas will be more affected by the tilt changes. To effectively select the bins for the optimization, the system uses two techniques that are similar to importance sampling and learning from hard samples.

To select the bins for B, the system computes average variances as an indicator of informativeness. For every antenna A and bin b, the system uses the ray tracer RHEA to compute the variance v_{A,b} of the signal strengths across all tilt levels. If the average variance

$${\overline{v}}_{b} = \frac{1}{n} {\sum }_{A = 1}^{n} {v}_{A , b}$$

over all the n antennas is below a threshold t_{gis}, then bin b is considered non-informative. Hence, during training, the subsets of bins are drawn from the set {b|v̅_{b}>t_{gis}} of bins b whose variance exceeds the threshold. In an embodiment, t_{gis}=3 dBm. This selection strategy is referred to as geospatial importance sampling (GIS), because it implicitly encodes the global geospatial information into the selection of training data. Ablation studies show that GIS is critical to the performance of the method for RL 204b described above. Notably, policy nets trained on all the bins perform consistently worse than those trained only on informative bins.

Naive models of the signal strength only rely on the Euclidean distance of the bins from each antenna. Such models do not fully use the geospatial environment and do not take into account the effect of obstructions by geospatial objects on the signal strength in different bins. To examine the effect of the geospatial objects, CNMF 204 computes a multi-path coefficient of each bin. This coefficient is defined for antenna A and bin b, let S_{A,b} be the strength of the signal from A at b while considering all the paths between the antenna and the bins, including indirect ones due to reflection and refraction. Let

$${s}_{A , b}^{′}$$

be the strength of the signal from A at b when considering only the direct path (if a line of sight exists between A and b). Define

$${r}_{A , b} = 1 - {S}_{A , b} / {s}_{A , b}^{′}$$

as the multi-path coefficient. When r_{A,b} is far from 0, there is a significant effect of the geospatial objects on the signal strength in the bin. When r_{A,b} is positive, it is typically because of blockage of the line of sight. When r_{A,b} is negative, it is because of reflections that add strength to the indirect signal. When r_{A,b} is close to 0, the effect of the obstacles is small.

FIG. 2B depicts an illustrative embodiment of a method of training a reinforcement learning model to optimize cellular network coverage in accordance with various aspects described herein. Method 210 begins at step 211 where the system partitions a geographic area into bins. Next in step 212, the system initializes settings and assigns an agent to each antenna providing communication services to user equipment in the geographic area. Next in step 213, each agent will take an action that adjusts settings for network parameters for the antenna to improve coverage quality. The system computes an updated coverage quality, signal strength and interference for each bin based on the settings adjusted by the agent. Next in step 214, the system evaluates the outcome and rewards the agents based on the computation, then records the updated coverage quality, the signal strength and the interference in a history.

Next in step 215, the system determines whether a quality improvement goal for network coverage has been reached. If not, then the system repeats starting at step 213 at most a preset maximum number of times. But if the goal has been reached, then the process continues at step 216 where the system provides the history to a neural network as an epoch. The neural network incorporates each epoch of history and in step 217 repeats the process at step 212 at most a maximum number of epochs or until the neural network converges. Then the reinforcement learning model is fully trained and can be used to adjust network settings in the field. The process ends at step 218.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C are four graphs illustrating a distribution of different forms of geospatial information and alignment with a geospatial distribution of raytracing-based signal strength variance. As shown in FIG. 2C, a first graph 221 depicts buildings in the geospatial map, where darker red represents higher buildings. The antenna location is marked by a black star. A second graph 222 presents the spatial distribution of the signal-strength variance v_{A,b} (as defined above) of the antenna. Darker red represents higher variance, that is, bins where the coverage quality is more likely to change when altering the antenna tilt. Graph 223 shows the spatial distribution of the multi-path coefficients. Darker red means higher values. In graph 224, the colors are a function of the Euclidean distances between the bins and the antenna. Darker points are closer to the antenna. The spatial distribution of the multi-path coefficient aligns better with the ray-tracing results than with the Euclidean distances. Therefore, the policy net can use the multi-path coefficients to estimate which bins are more likely to be affected by antenna tilts and are significant for improving the overall coverage quality.

Reinforcement learning as described above was compared to three different baseline algorithms: greedy search, simulated annealing and Bayesian optimization. All of the algorithms were applied over the signal strengths computed by RHEA, using the same geospatial setting. A comparison with complicated deep learning models such as convolutional neural network (CNN) and attention models was not developed because these algorithms are too large and too slow to generate near real-time performance results.

Briefly, greedy search is a naive, deterministic optimization algorithm. An initial tilt setting is uniformly selected followed by a bounded number of search steps. At each step, greedy search computes the overall coverage quality after changing the tilt of a single antenna by at most one level. The selected change is the one that improves the coverage quality the most. Often, greedy search gets stuck at a local maximum.

Simulated annealing is a stochastic metaheuristic to approximate global optimization in a large search space. Like greedy search, it starts with a randomly selected initial tilt setting and its number of search steps is limited. At a given step, given a hyperparameter search range k, it randomly chooses an action that changes at most k antennas, by at most one level each. It computes a temperature parameter and accepts the action if quality improves, or otherwise, accepts the action with a probability. If the action is rejected, no action is executed at the given step. The value k gradually decreases with each iteration. In each step, simulated annealing applies bigger changes than the greedy search and it typically explores a larger subspace of the search space. So, while it may also get stuck in a local maximum, it typically finds better solutions than the greedy search and finds these solutions faster.

Bayesian optimization is a statistical method that searches for the optima of a black-box parametric function, i.e., a multi-variate function without a closed-form. The overall coverage quality is such a black-box parametric function of tilts. The strategy is to think of the black-box function as a sample drawn from a stochastic process, which is called the prior. A Gaussian process was used starting with a batch of random tilt settings and computing the overall coverage qualities by RHEA. Then the posterior probability of observing these overall coverage qualities given in a sample (i.e., a specification of the black-box function) are calculated from the prior. Next, the specification that has the highest probability is chosen as the estimation of the black-box function. Then, draw new random tilt settings based on the estimation and repeat the process until convergence or upon reaching the maximum steps.

FIG. 2D are two graphs illustrating an evaluation of a trained policy net compared to the baseline methods. The results are an average of over 1000 random initial tilt settings, each random initial tilt setting was tested in 5 independent runs. There are two major metrics: (1) overall coverage quality improvement; and (2) optimization time. A good balance between these two metrics is needed for performance. Experiments show that the reinforcement model can optimize the antenna tilts by a large margin tens or even hundreds of times faster than baseline methods. Graphs 231 and 232 show the relation between optimization time and the improvement in coverage quality. Graph 231 is for 16 antennas, and graph 232 is for 32 antennas. The units of the x-axis are seconds, in log-scale. Each marker represents a single optimization step. The abrupt surge of the Bayesian method illustrated in graph 231 arises from collecting random samples without estimating Gaussian processes, which take around 0.1 s compared to other steps, which take around 3 s.

The following is evident upon observation of graphs 231 and 232. First, greedy search consistently achieves the worst improvement. This is because the optimization problem is non-convex. Second, the reinforcement learning method improves the overall coverage quality by a large margin {50% to 100% more improvement than greedy search) and relatively fast (less than 0.05 s) compared to the baseline methods. Third, in the 16-antenna case illustrated in graph 231, simulated annealing takes ten times more time to achieve similar improvement as reinforcement learning, and Bayesian optimization takes nearly 200× more time. This gap increases to 40× and 400×, respectively, in the 32-antenna case. This is because random annealing takes significantly more steps to converge when the size of the search space increases, and the estimation process takes longer time for Bayesian optimization as the dimension of the search space increases. Fourth, though random annealing and Bayesian optimization can achieve higher improvement than reinforcement learning if given sufficient time, the trend we can see from comparing the 16-antenna case and the 32-antenna case is that optimization becomes more difficult as the number of antennas increases. This is because the size of the search space increases exponentially. Instead, the policy net scales up well because it learns to trim the search space based on observations and to select the action based on features of the geospatial environment.

FIG. 2E are two graphs illustrating an ablation study of a trained policy net compared to baseline methods demonstrating how geospatial importance sampling and multi-path coefficient improve the reinforcement learning. In the ablation studies, GIS and multi-path coefficients are removed and graphs 241 and 242 show how the performance changes in the 16 antenna and 32 antenna cases, respectively. RL denotes standard reinforcement learning with random mini-batching and without multi-path coefficients as input. RL+GIS denotes reinforcement learning with geospatial importance sampling but without multipath coefficients as input. RL+GIS+Euclid denotes reinforcement learning with geospatial importance sampling, but the multi-path coefficient is replaced by Euclidean distances from bins to antennas. These three variations are known as incomplete methods. RL+GIS+RHEA denotes the reinforcement learning method described above and is referred to as the complete method.

Graphs 241 and 242 illustrate the importance of GIS and multipath coefficients. First, the complete method outperforms the incomplete methods by a large margin. Second, reinforcement learning with geospatial importance sampling alone outperforms standard reinforcement learning by a large margin. Third, adding local geospatial information is not always helpful. By comparing RL+GIS and RL+GIS+Euclid, we can see that Euclidean distances do not provide useful information that the policy net can utilize to improve its decisions. Euclidean distances just introduce noise and degrade the training efficiency. Fourth, as the number of antennas increases, the gap between the complete method and the incomplete methods increases, while the gap among the incomplete methods decreases. So, as the optimization problem becomes more complex, neither global geospatial information nor local geospatial information alone is sufficient for the policy net to make correct decisions.

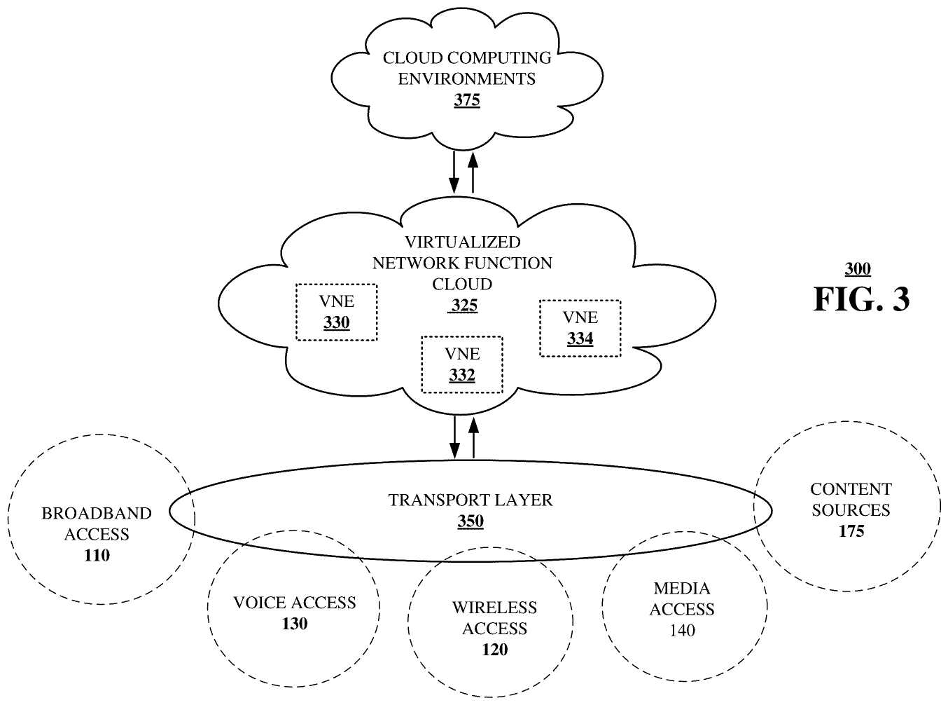

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 210 presented in FIGS. 1, 2A, 2B and 3. For example, virtualized communication network 300 can facilitate in whole or in part partitioning a geographic area into a plurality of bins; assigning an agent to each antenna; initializing random settings for the network parameters; computing updated coverage quality, signal strength and interference for each bin in the plurality at a setting proposed by the agent; recording the updated coverage quality, the signal strength and the interference in a history; rewarding the agent for improvements; and providing the history to a policy net as an epoch.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

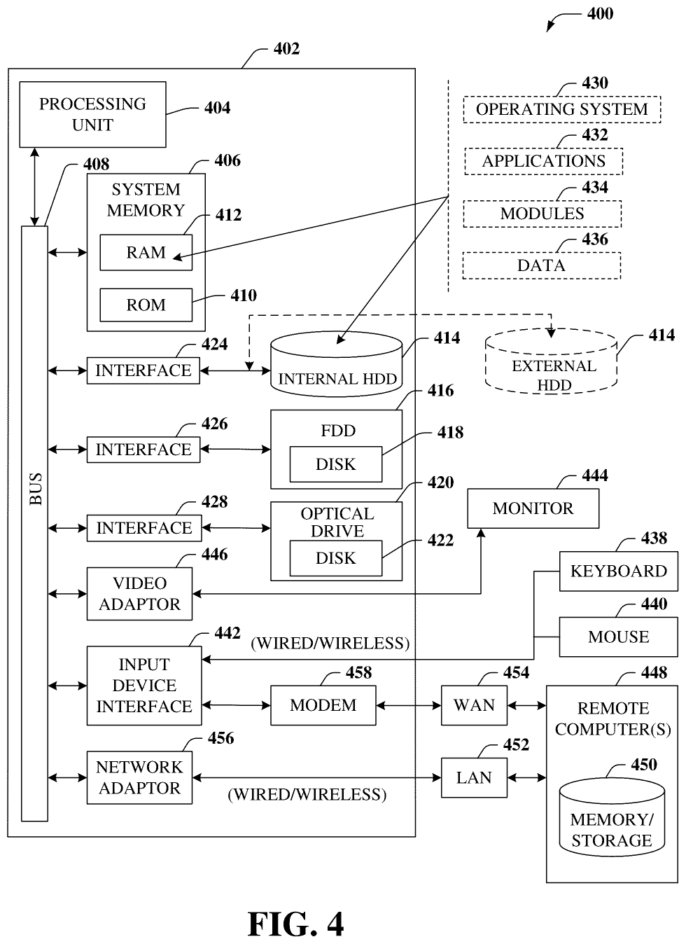

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a computing environment 400 suitable for implementing the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part partitioning a geographic area into a plurality of bins; assigning an agent to each antenna; initializing random settings for the network parameters; computing updated coverage quality, signal strength and interference for each bin in the plurality at a setting proposed by the agent; recording the updated coverage quality, the signal strength and the interference in a history; rewarding the agent for improvements; and providing the history to a policy net as an epoch.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

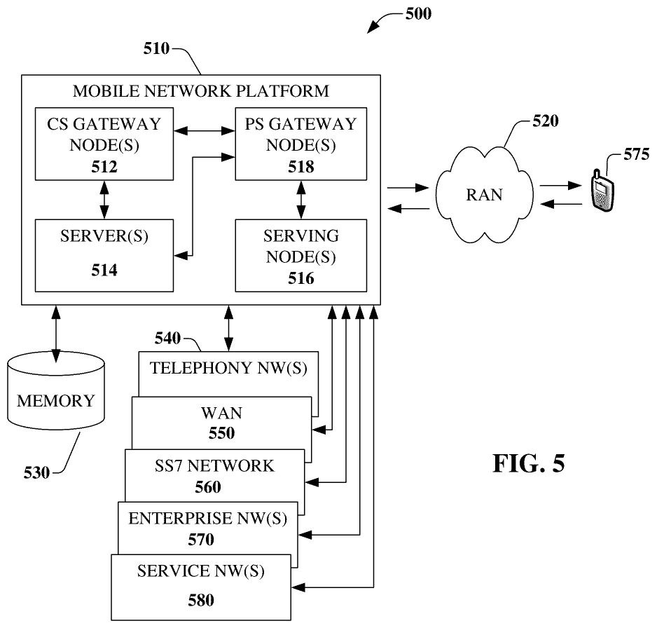

Turning now to FIG. 5, an embodiment 500 of a mobile network platform 510 is shown that is an example of network elements 150, 152, 154, 156, and/or VNEs 330, 332, 334, etc. For example, mobile network platform 510 can facilitate in whole or in part partitioning a geographic area into a plurality of bins; assigning an agent to each antenna; initializing random settings for the network parameters; computing updated coverage quality, signal strength and interference for each bin in the plurality at a setting proposed by the agent; recording the updated coverage quality, the signal strength and the interference in a history; rewarding the agent for improvements; and providing the history to a policy net as an epoch. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs 550), enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

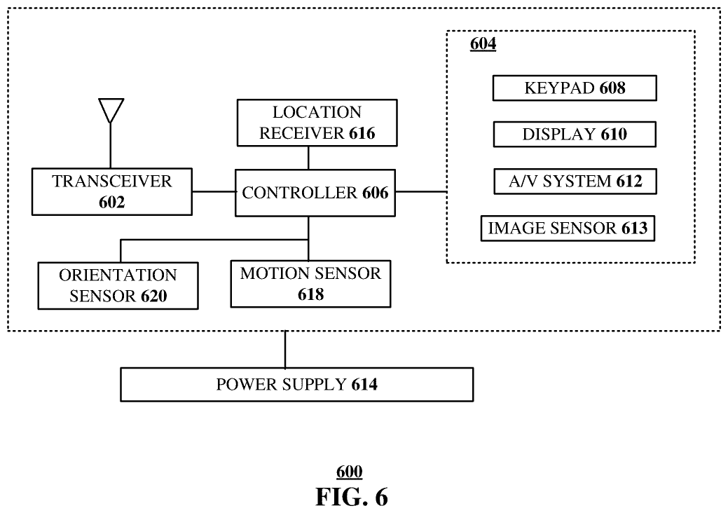

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part partitioning a geographic area into a plurality of bins; assigning an agent to each antenna; initializing random settings for the network parameters; computing updated coverage quality, signal strength and interference for each bin in the plurality at a setting proposed by the agent; recording the updated coverage quality, the signal strength and the interference in a history; rewarding the agent for improvements; and providing the history to a policy net as an epoch.

The communication device 600 can comprise a wireline and/or wireless transceiver (herein transceiver 602), a user interface (UI 604), a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals from an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
partitioning a geographic area into a plurality of bins;
assigning an agent to each antenna that provides communication services in the geographic area, wherein the agent executes an action that adjusts settings for network parameters for the antenna to improve coverage quality;
initializing random settings for the network parameters;
computing updated coverage quality, signal strength and interference for each bin in the plurality at a setting proposed by the agent;
recording the updated coverage quality, the signal strength and the interference in a history;
rewarding the agent for improvements;
repeating the computing, the recording and the rewarding a preset maximum number of times at most or until an overall coverage quality improvement has reached a goal;
providing the history to a policy net as an epoch; and
iterating the initializing, computing, recording, rewarding and repeating a maximum number of epochs at most or until the policy net has converged.

2. The device of claim 1, wherein the computing selects only a subset of bins based on selected bins having an average variance in the signal strength computed by a geospatial ray tracing algorithm that exceeds a threshold.

3. The device of claim 1, wherein the agent executes an action that adjusts settings for network parameters for the antenna to decrease interference.

4. The device of claim 3, wherein the geospatial ray tracing algorithm analyzes a detailed 3D model of the geographic area.

5. The device of claim 1, wherein the computing of the signal strength includes a multi-path coefficient.

6. The device of claim 1, wherein the network parameters include antenna tilt, power, beam width, transmission frequency, or a combination thereof.

7. The device of claim 1, wherein the rewarding comprises a stepwise penalty, an individual improvement reward, a global improvement reward, a winning reward, a lose penalty, or a combination thereof.

8. The device of claim 1, wherein the policy net comprises a three-layer feed-forward neural network with a rectified linear unit activation.

9. The device of claim 1, wherein the processing system comprises a plurality of processors operating in a distributed computing environment.

10. A non-transitory machine-readable medium, comprising executable instructions that, when executed by a processing system including a processor, facilitate performance of operations, the operations comprising:
implementing a geospatial ray tracer that computes signal strength of a radio frequency emission from an antenna at a location bin in a geographical area,
wherein the geospatial ray tracer uses a multi-path coefficient to compute the signal strength,
wherein the geospatial ray tracer computes coverage quality for the location bin responsive to an average variance of the signal strength exceeding a threshold, and
wherein the coverage quality is provided to a reinforcement learning model; and
training the reinforcement learning model to discover network parameter settings that maximize radio communication coverage and minimize radio frequency interference in the geographical area.

11. The non-transitory machine-readable medium of claim 10, wherein the geospatial ray tracer analyzes a detailed 3D model of the geographic area.

12. The non-transitory machine-readable medium of claim 10, wherein the network parameter settings include antenna tilt.

13. The non-transitory machine-readable medium of claim 10, wherein the reinforcement learning model rewards an agent for each antenna, and wherein the rewarding comprises a stepwise penalty, an individual improvement reward, a global improvement reward, a winning reward, a lose penalty, or a combination thereof.

14. The non-transitory machine-readable medium of claim 10, wherein the reinforcement learning model comprises a three-layer feed-forward neural network with a rectified linear unit activation.

15. The non-transitory machine-readable medium of claim 10, wherein the processing system comprises a plurality of processors operating in a distributed computing environment.

16. A method, comprising:
assigning, by a processing system including a processor, an agent to each antenna that provides communication services in a geographic area, wherein the geographic area is partitioned into a plurality of bins, and wherein the agent executes an action that adjusts settings for network parameters for the antenna to improve coverage quality;
initializing, by the processing system, random settings for the network parameters;
computing, by the processing system, updated coverage quality, signal strength and interference for each bin in the plurality at a setting proposed by the agent;
recording, by the processing system, the updated coverage quality, the signal strength and the interference in a history;
rewarding, by the processing system, the agent for improvements;
repeating, by the processing system, the computing, the recording and the rewarding a preset maximum number of times at most or until an overall coverage quality improvement has reached a goal;
providing, by the processing system, the history to a policy net as an epoch; and
iterating, by the processing system, the initializing, computing, recording, rewarding and repeating a maximum number of epochs at most or until the policy net has converged.

17. The method of claim 16, wherein the computing selects only a subset of bins where each bin selected has an average variance in the signal strength that exceeds a threshold.

18. The method of claim 17, wherein the average variance is computed by a geospatial ray tracing algorithm.

19. The method of claim 17, wherein the computing of the signal strength includes a multi-path coefficient.

20. The method of claim 17, wherein the network parameters include antenna tilt.
